(19) United States
(12) Patent Application Publication
(10) Pub. No.: US 2026/0316100 A1
(43) Pub. Date: Oct. 15, 2026

(54) SPRAY GUN WITH REPOSITIONABLE TRIGGER

(71) Applicant: 3M INNOVATIVE PROPERTIES COMPANY, ST. Paul, MN (US)

(72) Inventors: Brian F. Moy, Arden Hills, MN (US); Scott D. Gullicks, River Falls, WI (US)

(21) Appl. No.: 19/476,494

(22) PCT Filed: Apr. 25, 2024
(86) PCT No.: PCT/IB2024/054061

§ 371 Date: Oct. 17, 2025

Related U.S. Application Data
(60) Provisional application No. 63/461,839, filed on Apr. 25, 2023.

(51) Int. Cl. B05B 7/12; B05B 7/04

(52) U.S. Cl. CPC B05B 7/12; B05B 7/0416

(57) ABSTRACT

Aspects of the present disclosure relate to a spray gun system having a trigger. The trigger includes a first trigger body arranged along a trigger axis that includes a body segment at a distal end of the first trigger body leading to a pair of yoke arms at a proximal end. The trigger includes a trigger-needle engagement structure positioned between the first yoke arm and second yoke arm. In one embodiment, each yoke arm comprises a plurality of pivot holes formed therein towards a proximal end of the first trigger body, the plurality of pivot holes are dimensioned similarly so that each pivot hole is engageable with the engagement structure. The spray gun system comprises a needle valve comprising a needle disposed at least partially within the spray gun platform and configured to engage with the trigger-needle engagement structure of the trigger.

### BACKGROUND

Spray equipment is used in many processes including surface coating applications, combustion, and chemical reaction control. Spray equipment can include devices that transform bulk liquids into a fine spray or mist of droplets. The size and shape of spray equipment can depend upon the desired application and/or delivery system. Applications over the years have included delivery of gas hydrocarbon feeds in fluidized catalytic cracking processes, dispensing of chemical insecticides, and application of protective or aesthetic surface coatings.

Spray equipment can be used, for example, in vehicle repair body shops to apply liquid coating media such as primer, paint and/or clearcoat to vehicle parts. Spray equipment such as a spray gun can be made of combination of metal and polymeric materials and includes a platform and spray head assembly. The spray head assembly includes a nozzle for dispensing the liquid, one or more atomizing gas outlets to atomize the liquid as it exits the nozzle, and two or more shaping gas outlets to shape the atomized liquid into the desired spray pattern. The spray gun contains a series of internal passages that distribute gas from a gas supply manifold in the platform to the atomizing gas outlet(s) and shaping gas outlets in the spray head assembly. Such spray guns are sometimes referred to as the air-atomizing, air-spray, air-assist, or air-blast type.

### BRIEF SUMMARY

In some designs, manually-operated valves such as a needle valve are used to control the flow of coating liquid through the spray gun (see for example, FIG. 1, and FIG. 2). The needle (or valve stem) is located along a central axis of the nozzle and shuts off on the valve seat (nozzle sealing surface) near the liquid outlet. The needle/stem is typically connected to a trigger as a means of actuation by the user's hand. When the trigger is pulled back by the user, the needle will slide away from the valve seat and allow liquid to flow through the passage outlet. When the trigger is released, a biasing mechanism (e.g., spring) is used to push the needle back to its closed position in contact with the valve seat. Along the length of the needle, seals (or packings) are used to isolate liquid within the flow passage from the external region of the spray gun.

These triggers found in the aforementioned spray gun system is often difficult to control since the user may want to control the needle valve to a greater extent than the default settings allow. By having an adjustable pivot hole configuration, the user can further customize the control of the manually-operated valve.

Aspects of the present disclosure relate to a spray gun system. The spray gun system includes a spray gun platform, an engagement structure that is configured to be installed at an engagement hole formed within the spray gun platform, and a trigger pivotably configured to attach to the spray gun platform via the engagement structure. The trigger includes a first trigger body arranged along a trigger axis that includes a body segment at a distal end of the first trigger body leading to a pair of yoke arms at a proximal end. The trigger includes a trigger-needle engagement structure positioned between the first yoke arm and second yoke arm. In one embodiment, each yoke arm comprises a plurality of pivot holes formed therein towards a proximal end of the first trigger body, the plurality of pivot holes are dimensioned similarly so that each pivot hole is engageable with the engagement structure. The spray gun system comprises a needle valve comprising a needle disposed at least partially within the spray gun platform and configured to engage with the trigger-needle engagement structure of the trigger. The needle is configured to be translatable along a spray axis in response to a pivoting motion of the trigger.

Additional aspects of the present disclosure relate to a method of adjusting the spray gun system. The method can include removing the engagement structure from a first pivot hole to release the first trigger body from a first configuration. The method can include aligning a second pivot hole of the first trigger body with the engagement hole which changes a position and orientation of the trigger relative to the spray gun to a second configuration. The method can also include installing the engagement structure to through the second pivot hole, which maintains the second configuration.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a cross-sectioned side view of a prior art spray gun system in accordance with one embodiment.

FIG. 2 illustrates a cross-sectioned side view of a prior art spray gun system in accordance with one embodiment.

FIG. 3A illustrates a perspective view of a trigger in accordance with one embodiment.

FIG. 3B illustrates a side-view of the trigger in FIG. 3A in accordance with one embodiment.

FIG. 4A illustrates a side-view of a trigger in a first configuration in accordance with one embodiment.

FIG. 4B illustrates a side-view of a trigger having a second trigger body being pivoted about an engagement structure in accordance with one embodiment.

FIG. 5 illustrates a trigger having overlapping pivot holes in accordance with one embodiment.

FIG. 6A illustrates a spray gun system having a trigger in a first configuration in accordance with one embodiment.

FIG. 6B illustrates the spray gun system of FIG. 6A having the trigger in a second configuration in accordance with one embodiment.

### DETAILED DESCRIPTION

The spray equipment of the present disclosure can allow a user to create a spray of atomized liquid for use in a variety of coating applications. Such coating applications can be performed to enhance appearance, impart corrosion protection, impart abrasion resistance, increase moisture resistance, and improve cleanability of substrates.

Aspects of the present disclosure relate to spray equipment that use a trigger having an adjustable pivot point such that the trigger has an adjustable position/angle relative to hand grip portion of the spray gun platform. The trigger can engage with a manually-operated valve such as a needle valve (having a needle). Such a trigger can allow for more comfortable user ergonomics and/or allow for finer control of the liquid amount atomized.

Although spray equipment of the present disclosure is designed to address some of the drawbacks associated with current manual, hand-held spray guns, as mentioned above, it should be understood that the concepts disclosed herein could be easily configured for other devices and/or applications that atomize liquid without straying from the scope of the present disclosure.

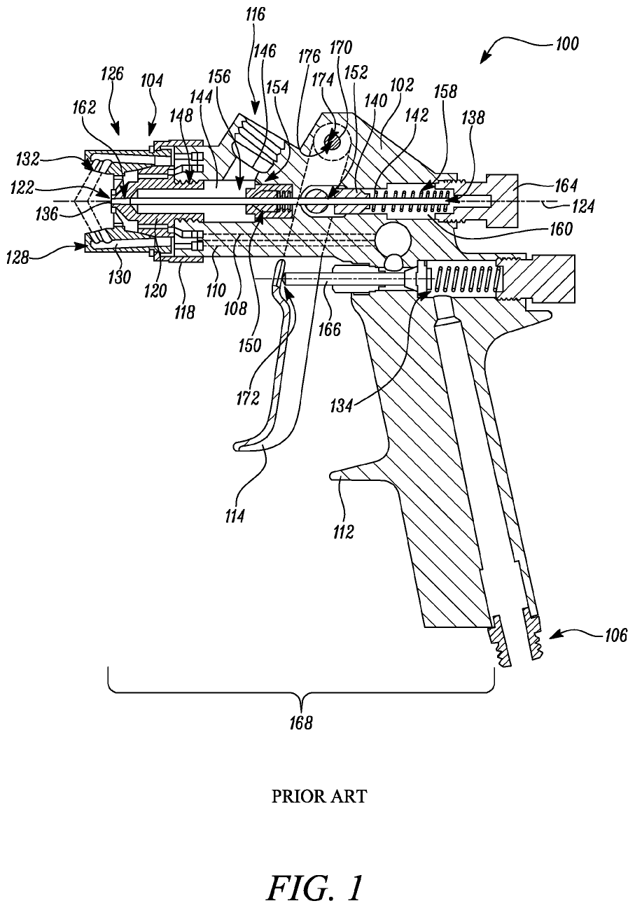

FIG. 1 illustrates a spray gun system 100. The spray gun system 100 includes a spray gun platform 102 and a nozzle assembly 104.

The spray gun platform 102 includes a gas inlet 106 that is configured to couple with a gas source (not shown). The spray gun platform 102 can also include a grip portion 112, trigger 114, and liquid inlet 116 for connection to a compatible liquid reservoir system(not shown).

In at least one embodiment, a liquid passageway 144 can be formed within the spray gun platform 102 between the liquid inlet 116 and a liquid outlet 122. The liquid passageway 144 can also include a liquid chamber 146. If the nozzle assembly 104 is removed, then the liquid passageway 144 can be formed between the liquid inlet 116 and an opening adjacent to the attachment structure 148 where the spray gun platform 102 can attach to the nozzle assembly 104.

In at least one embodiment, the liquid passageway 144 (e.g., liquid chamber 146) can share portions with a needle passageway 160 (e.g., portions of wettable needle chamber 156). The needle passageway 160 is configured to hold a needle 138 used in operation of the spray gun system 100. The needle passageway 160 can be configured to allow a needle 138 to axially pass thru the spray gun platform 102 and/or nozzle assembly 104. In at least one embodiment, the needle passageway 160 is formed in portions of the nozzle assembly 104 and the spray gun platform 102. The needle passageway 160 can have a length dimension 168 that is approximately the size of the needle 138.

The needle passageway 160 can include a non-wettable needle chamber 158, and a wettable needle chamber 156 which is separated from a non-wettable needle chamber 158 via a secondary opening 154 and/or packing seal 150. In at least one embodiment, the secondary opening 154 leads into the wettable needle chamber 156 and divides the wettable needle chamber 156 from the non-wettable needle chamber 158.

In at least one embodiment, the wettable needle chamber 156 is a portion of the needle passageway 160 that is configured to contact the liquid. Both the wettable needle chamber 156 and the non-wettable needle chamber 158 can each further include one or more chambers. In at least one embodiment, the needle passageway 160 can be oriented parallel or coaxially with the spray axis 124.

In at least one embodiment, a needle 138 has a needle boss 140 that is configured to engage with a trigger-needle engagement structure 152 (e.g., formed as part of the trigger 114) and a biasing mechanism 142. The biasing mechanism 142 can further abut against an adjustment knob 164. The adjustment knob 164 can restrict movement of the needle 138 in a direction opposite from the needle tip 136 along the spray axis 124. In at least one embodiment, the needle 138 can be disposed axially within the needle passageway 160 such that is capable of translational movement. In at least one embodiment, a packing seal 150 can be used to slidably seal the needle 138 against the secondary opening 154. The packing seal 150 can divide the wettable needle chamber 156 from the non-wettable needle chamber 158. A fluid tight seal between the spray gun platform 102 and liquid inlet 116 can be formed through the packing seal 150. Over time, the packing seal 150 may wear, and as such, can be replaced.

The spray gun platform 102 can have gas passageways (e.g., shaping gas passageway 110, and atomizing gas passageway 108) formed therein and fluidically coupled to the gas inlet 106 at one end. At the opposite end, the gas passageway can releasably engage to gas passageways within the nozzle assembly 104.

In at least one embodiment, the nozzle assembly 104 can be a nozzle cartridge.

As shown, the nozzle assembly 104 can be coaxial or parallel with the spray axis 124. For example, the nozzle assembly 104 can include a spray gun nozzle body 120 having a nozzle gas inlet and a nozzle gas outlet (e.g., the annular opening) which forms an atomizing gas passageway therebetween. The spray gun nozzle body 120 has a nozzle liquid passageway that is aligned along the spray axis 124 and a nozzle liquid inlet that is configured to couple to a liquid outlet (e.g., liquid chamber) on the spray gun platform 102. The secondary opening 154 is located in the spray gun platform 102 as shown. In at least one embodiment, the secondary opening 154 can be collocated with the packing seal 150 and can divide the wettable needle chamber 156 from the non-wettable needle chamber 158.

The atomizing gas passageway is configured to be removably coupled to an atomizing gas passageway 108 of the spray gun platform 102.

The nozzle assembly 104 can include spray gun nozzle body 120, retaining ring 118, air cap 126. Air cap 126 can include an annular opening and two or more diametrically opposed air horns 128 containing horn passageways 130 which terminate at horn outlets 132. Although air horns 128 and air cap 126 are used to describe this configuration, various other gases and/or carrier fluids besides air may also be used.

The spray gun nozzle body 120 can include a liquid outlet 122 that is sealed with a needle tip 136 interacting with a nozzle sealing surface of nozzle wall to form a needle-nozzle seal 162.

The spray gun nozzle body 120 can also include a nozzle liquid inlet and a liquid outlet 122 forming the nozzle liquid passageway therebetween. The nozzle liquid passageway can be configured to (1) be removably coupled to a liquid passageway 144 of the spray gun platform 102 at a second end and (2) form a needle-nozzle seal 162 with a needle 138 of the spray gun platform 102 at a first end opposite from the second end.

The spray gun nozzle body 120 can further include an attachment structure (disposed on an outside surface) for attaching to an attachment structure 148 on the spray gun platform 102 and releasably engage.

The grip portion 112 of the spray gun platform 102 can have a grip axis (not shown) extending distally toward the end of the grip portion 112. The grip axis and spray axis 124 can form a plane and the trigger 114 (and trigger axis) can be configured to be coplanar with this plane formed by the grip axis and the spray axis 124).

The trigger 114 can be attached to the spray gun platform 102 at the engagement structure 170. The engagement structure 170 can be a pivot pin, screw, rivet, bolt, or other mechanical part that allows releasable engagement of the trigger 114 with the spray gun platform 102. The engagement structure 170 can be configured to mate with an engagement hole 174 formed within the spray gun platform 102. For example, the engagement structure 170 can be pushed through a pivot hole 176. In one embodiment, the engagement structure 170 has an axis that perpendicular relative to a spray axis 124 of the spray gun platform 102 (when installed in engagement hole 174).

The trigger 114 can also include a trigger-needle engagement structure 152. The trigger-needle engagement structure 152 can engage with a portion of the needle 138 such as the needle boss 140. In one embodiment, the trigger-needle engagement structure 152 is a crossbar between the yoke arms that engages with the needle boss 140. In one embodiment, the crossbar integrally formed with the trigger.

To operate the spray gun system 100, a user's hand depresses the trigger 114 which actuates gas valve 134 via the poppet valve 166 and also causes needle 138 to translate (via needle boss 140 and biasing mechanism 142) along spray axis 124 away from the nozzle sealing surface of the needle tip 136. The actuation of gas valve 134 allows gas to flow from the gas inlet 106, through gas valve 134, and into a shaping gas passageway 110, and an atomizing gas passageway 108. In one embodiment, the trigger-gas valve engagement structure 172 engages (directly) with the gas valve 134.

In operation, gas from the atomizing gas passageway can flow along the exterior of nozzle wall and through annular opening (i.e., forming a gas outlet) creating a venturi effect which pulls liquid from a liquid reservoir system through the liquid inlet 116 and nozzle liquid passageway until the liquid exits the spray gun nozzle body 120 at liquid outlet 122 where the gas atomizes the liquid at a mixing zone. In some embodiments, the liquid reservoir system can benefit from gravity (gravity-fed) and/or pressure assistance (pressure-fed). For example, the liquid reservoir system can be pressure assisted which can allow handling of viscous liquids.

The mixing zone is where a stream of gas from the atomizing gas passageway exiting the annular opening merges, interacts with, intersects, and/or atomizes a stream of liquid from the nozzle liquid passageway exiting the liquid outlet 122. Gas can exit the horn passageway 130 at horn outlet 132 to shape the atomized liquid creating an approximately elliptical spray pattern.

When the trigger 114 is released, a biasing mechanism (such as a spring or even the gas valve 134) can bias the needle 138 against the nozzle sealing surface to a closed position (thus forming the needle-nozzle seal 162), which shuts off the flow of liquid.

In at least one embodiment, the spray gun system 100 can include a spray gun platform 102 that has both the nozzle liquid passageway and atomizing gas passageway formed therein. Thus, to clean the spray gun system 100, the air cap 126 and the spray gun nozzle body 120 are removed.

In one embodiment, the spray gun system 100 includes a nozzle assembly 104 or nozzle cartridge. The nozzle assembly 104 includes a liquid outlet 122 and a gas outlet adjacent to the liquid outlet 122. In one embodiment, the spray gun system 100 is configured to deliver liquid through the liquid outlet 122 in response to pressurized gas flowing through the gas outlet based on the actuating of a gas valve. The needle valve can operate the opening and closing of the liquid outlet 122.

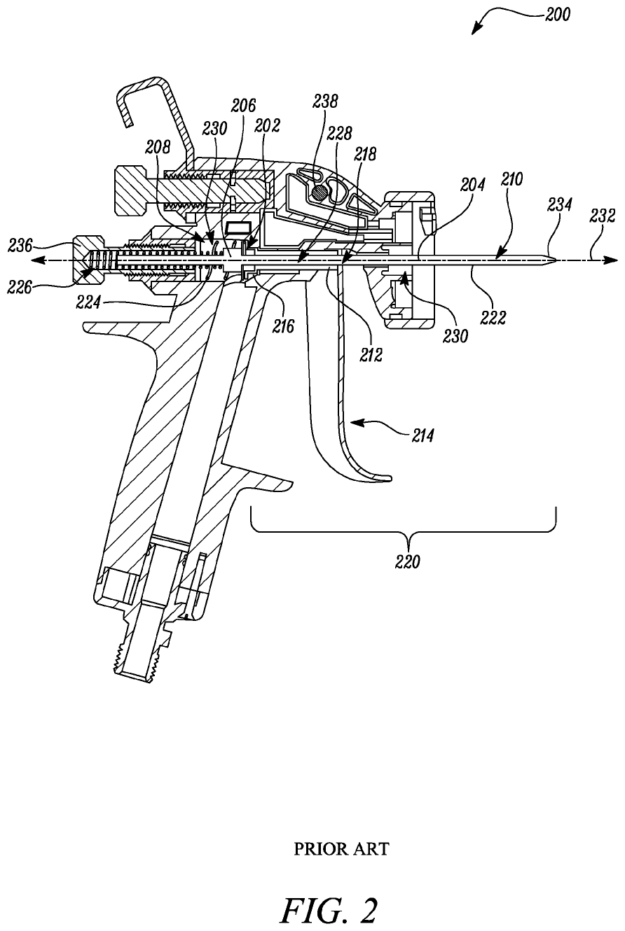

FIG. 2 illustrates a spray gun platform 200 similar to spray gun platform 102 except that the spray gun platform 200 can uses a poppet valve 202 which is coaxial with the needle 210 (FIG. 1 illustrates a stacked configuration between poppet valve 166 and needle 138). In at least one embodiment, the poppet valve 202 can regulate the gas flow while the needle 210 can regulate the liquid flow.

The non-wettable needle chambers 230 can include needle chamber 204 (forward) and needle chamber 208 (rear). The needle chamber 208 can be separated from needle chamber 204 via an air gap.

The needle 210 can include a shaft section 222 and a needle boss 206 configured to engage with both the poppet valve 202 (i.e., at the poppet flange end 216) and the needle biasing mechanism 226. The needle 210 can also include a needle tip 234 configured to engage with a nozzle sealing surface on a corresponding nozzle assembly (not shown). The shaft section 222 can have a dimension 220.

In one embodiment, the spray gun platform comprises a poppet valve that engages with both the gas valve and the needle at a trigger-needle engagement structure.

The poppet valve 202 can include a poppet flange end 216 and a poppet distal end 212. A thru passageway 228 can be formed from the poppet flange end 216 to the poppet distal end 212 within a body of the poppet valve 202. The needle 210 can pass thru the thru passageway 228 such that the poppet valve 202 surrounds the needle 210.

In at least one embodiment, the poppet flange end 216 is configured to engage a needle boss 206 and poppet biasing mechanism 224. The adjustment knob 236 is configured to provide a backstop to the needle biasing mechanism 226 and optionally the poppet biasing mechanism 224 such that both the needle 210 and the poppet valve 202 are biased towards the needle tip 234.

In one embodiment, the spray gun platform 200 or spray gun system can include a needle valve comprising a needle 210 disposed at least partially within the spray gun platform 200 and configured to engage with the trigger-needle engagement structure 218 of the trigger 214. In one embodiment, the needle 210 is configured to be translatable along a spray axis in response to a pivoting motion of the trigger 214.

A trigger 214 can have a pair of pivot holes (not shown) that engage with an engagement structure 238 and engagement hole formed within the spray gun body. A trigger 214 can engage with the poppet distal end 212 at the trigger-needle engagement structure 218 such that gas is discharged when the trigger 214 is activated and the trigger 214 is configured to translate the needle 210 along the spray axis 232 in response to activation.

When combined with a compatible nozzle assembly (not shown), the needle tip 234 can form a needle-nozzle seal with the nozzle wall in a first mode with no liquid being expelled (when present in the liquid passageway), and the needle-nozzle seal can be broken in response to a second mode, with the poppet valve 202 being opened. In at least one embodiment, the nozzle assembly can couple with a liquid reservoir system and the liquid passageway is not routed through the spray gun platform 200 in a nozzle cartridge configuration. In at least one embodiment, the nozzle assembly can be configured similar to nozzle assembly 104, where the liquid passageway is formed within the spray gun platform 200.

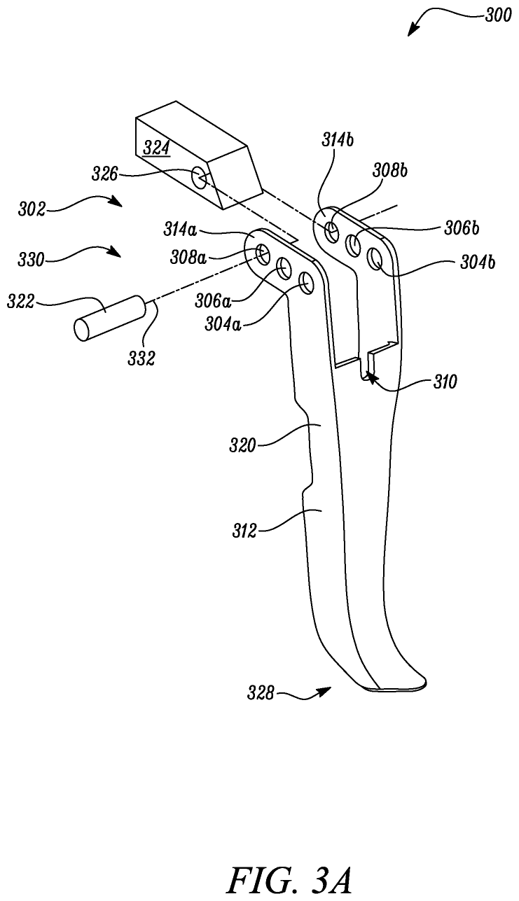

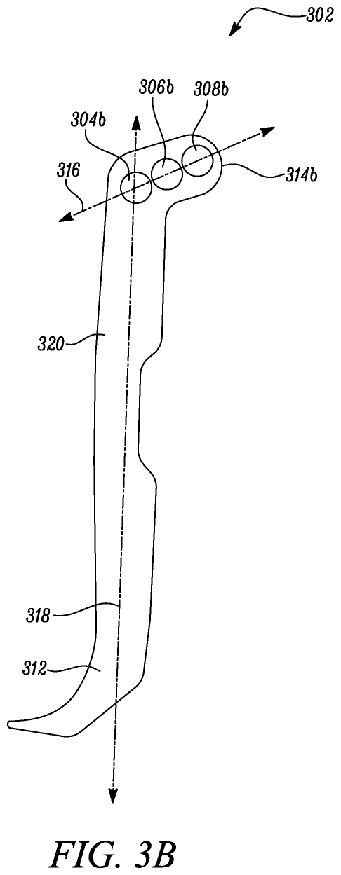

FIG. 3A and FIG. 3B illustrate an embodiment of a spray gun system described herein. The spray gun system 300 can include a spray gun platform 324, an engagement structure 322, and a trigger 302. The spray gun platform 324 can be an embodiment of either the spray gun platform 102 or spray gun platform 200 and be similarly configured. The spray gun platform 324 can include an engagement hole 326 formed therein through which an engagement structure 322 attaches the trigger 302 and secures the trigger 302 to the spray gun platform 324. In one embodiment, the engagement structure 322 is configured to be installed at an engagement hole 326 formed within the spray gun platform 324.

The trigger 302 is an embodiment of trigger 114 and trigger 214. The trigger 302 is pivotable about the engagement structure 322 and configured to attach to the spray gun platform 324 via the engagement structure 322 being received in the engagement hole similar to trigger 114 and trigger 214.

As shown herein, the trigger 302 can have a trigger body 320 arranged along a trigger axis 318 that includes a body segment 312 at a distal end 328 of the first trigger body leading to a pair of yoke arms (yoke arm 314a and yoke arm 314b) at a proximal end 330 (closest to the spray gun platform 324).

In one embodiment, the trigger 302 can have a trigger-needle engagement structure positioned between the first yoke arm 314a and second yoke arm 314b. The trigger-needle engagement structure can be a portion of the trigger 302 that allows clearance of a needle (not shown) and/or engages with a gas valve or poppet valve depending on the configuration of the spray gun platform. In one embodiment, the trigger-needle engagement structure is a cutout 310 formed within the body segment 312 of the trigger body 320. The trigger-needle engagement structure can engage indirectly with a gas valve via a poppet valve in some configurations. The cutout 310 can be dimensioned to not interfere with the needle disposed along a spray axis of the spray gun system but engage with a poppet distal end.

In one embodiment, each yoke arm (yoke arm 314a, yoke arm 314b) comprises a plurality of pivot holes formed therein towards a proximal end 330 of the trigger body 320. In one embodiment, there are at least two pivot holes, or at least three pivot holes per yoke arm. For example, on yoke arm 314a, pivot hole 308a, pivot hole 306a, and pivot hole 304a can be formed therein. On yoke arm 314b, pivot hole 308b, pivot hole 306b, pivot hole 304b can be formed therein. The plurality of pivot holes are dimensioned similarly so that each pivot hole is engageable with the same engagement structure 322.

In one embodiment, the plurality of pivot holes are aligned along the engagement structure axis 332 in pairs between the yoke arms (yoke arm 314a, and yoke arm 314b). In one embodiment, the plurality of pivot holes from yoke arm 314a is aligned in the engagement structure axis 332 with the plurality of pivot holes 406 from yoke arm 314b. For example, the engagement structure 322 can contact and connect the pivot hole 308a, engagement hole 326, and pivot hole 308b, when the trigger 302 is installed on the spray gun platform 324. In one embodiment, the engagement structure 322 can be releasably engaged with the trigger 302 such that the position of the trigger 302 can be adjusted through changing which pivot hole from the plurality of pivot holes 406 the engagement structure 322 engages with.

In one embodiment, the trigger 302 can be oriented along a trigger axis 318, which is generally an axis that runs through the axial center of the body segment 312 and yoke arms. In one embodiment, the trigger axis 318 can intersect with a pivot hole from the plurality of pivot holes (e.g., pivot hole 304a and pivot hole 304b). In one embodiment, the pivot hole 304a can be aligned with the trigger axis 318 and a second pivot hole from the plurality of pivot holes (e.g., pivot hole 304b) is offset from the trigger axis 318.

In one embodiment, the plurality of pivot holes can be in a staggered arrangement. In one embodiment, the plurality of pivot holes on a yoke arm can be arranged linearly along an adjustment axis 316. The adjustment axis 316 can be related to potential pivot hole positions for the engagement structure 322 to be inserted through when being also inserted through the engagement hole 326. In at least one embodiment, the adjustment axis 316 can be a linear regression through the plurality of pivot holes.

In one embodiment, the first pivot hole 304b and the second pivot hole 306b are aligned along an adjustment axis 316 and the adjustment axis 316 is non-orthogonal to the trigger axis 318.

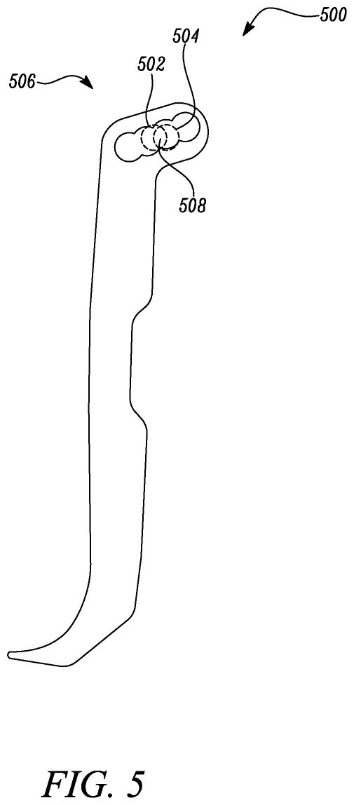

In one embodiment, the plurality of pivot holes can be formed of separate, distinct holes. These holes can be separate such that any engagement structure 322 will need to be removed in order to change position of the trigger 302. In one embodiment, the plurality of pivot holes can be linked through linking channels formed in the yoke arm or with multiple holes (forming a larger opening) as shown on FIG. 5.

The plurality of pivot holes can be linked through passageways formed in the first trigger body between the pivot holes, and engagement hole 326 of the spray gun platform 324. In one embodiment, the engagement structure 322 can secure the trigger 302 and the engagement hole 326.

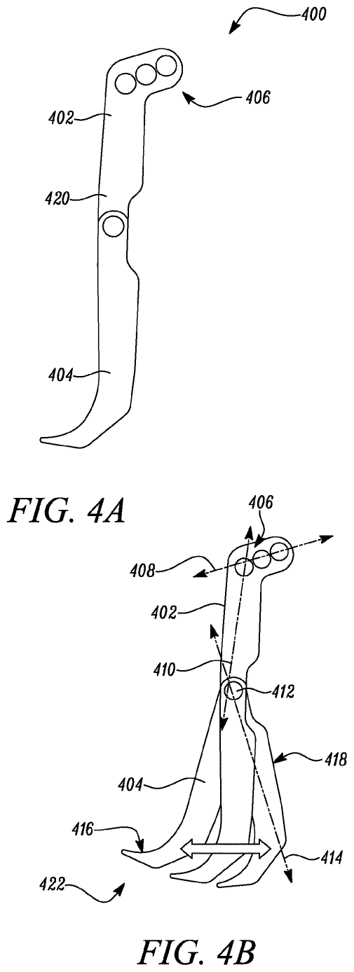

FIG. 4A and FIG. 4B illustrate a trigger 400 with two parts for further adjustability. For example, the trigger 400 can include a trigger body 402 and trigger body 404 that are linked through engagement structure 412. The engagement structure 412 can be a screw, a rivet, or a crossbar that allows the trigger body 404 to be releasably engaged and fixed relative to trigger body 402.

The trigger body 402 can include a plurality of pivot holes 406 and be configured similarly to the trigger body 320 shown in FIG. 3A. For example, the plurality of pivot holes 406 can be arranged linearly forming an adjustment axis 408. If staggered, then any two pivot holes can form the adjustment axis (but the adjustment axis 408 can be established by the first and last pivot holes).

The trigger axis 410 can be established by the engagement structure 412 and (e.g., a first relative to the spray direction) pivot hole from the plurality of pivot holes 406. The trigger axis 414 can be established by an axis of rotation of the trigger body 404. In one embodiment, the trigger axis 414 is established by a vertical axis of the trigger body 404.

The trigger body 404 can be attachable to the trigger body 402 at a body member 420 of the trigger body 402 (not the yoke arms).

The trigger body 404 can be configured to interact with the user's fingers when the trigger 400 is attached to the spray gun platform. For example, during adjustment, the distal end 422 of the trigger body 404 can be pivotable relative to the trigger body 402. The engagement structure 412 can act as a pivot point for the trigger body 404 as the distal end 422 moves from a first position 416 to a second position 418. Once adjusted, the user can fix the position and install the trigger 400 onto the spray gun platform.

FIG. 5 illustrates an embodiment of an adjustable trigger 500 having a plurality of pivot holes 506. In trigger 500, the plurality of pivot holes 506 can be at least partially overlapping meaning that the projected circumference of pivot hole 502 can overlap with the projected circumference of pivot hole 504 (thus, creating overlapping region 508). This overlapping region 508 can allow the trigger to slide into position without complete removal of the engagement structure. In one embodiment, plurality of pivot holes 506 can be considered to be a large pivot hole having a plurality of smaller overlapping pivot holes.

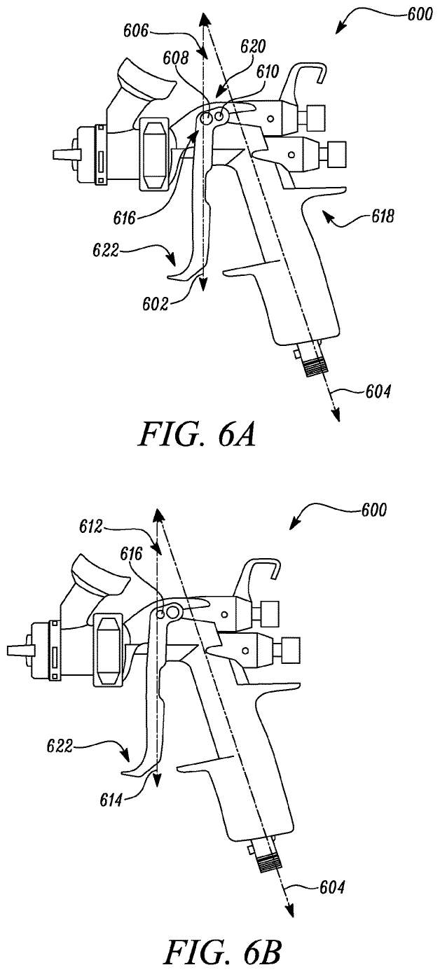

FIG. 6A and FIG. 6B illustrate spray gun system 600 in multiple configurations. For example, FIG. 6A illustrates the pivot hole 616 in a first configuration and FIG. 6B illustrates the pivot hole 616 in a second configuration.

The spray gun system 600 can include a spray gun platform 618 having a trigger 622 with two pivot holes (pivot hole 620 and pivot hole 616). The trigger 622 can be attached onto the spray gun platform 618 via an engagement structure 608 placed through a pivot hole 616 formed in the trigger 622.

As shown in FIG. 6A, the trigger 622 can have a trigger axis 602 formed through the pivot hole 616. The spray gun platform 618 can also have a grip axis 604. In the first configuration, the trigger axis 602 and the grip axis 604 form an angle 606.

To change from the first configuration to the second configuration, the user can remove the engagement structure 608 from the first pivot hole 620 to release the trigger 622 (including trigger body) for pivot hole 616 from the first configuration.

The user can then align the second pivot hole 610 of the trigger 622 with the engagement hole of the spray gun platform 618 which changes the position and orientation of the trigger 622 relative to the grip axis 604 to a second configuration.

The user can then install the engagement structure 608 through the pivot hole 610 which then allows the trigger 622 to pivot about the engagement structure 608 and pivot hole 610. The trigger axis 614 can form an angle 612 with the grip axis 604. In one embodiment, at rest, the angle 606 in the first configuration is different from angle 612 in the second configuration.

“Actuator” refers to a device or mechanism that is configured to manually control a gas valve from outside a gas valve body and/or outside of a spray gun body, or a spray gun component body. The term actuator can also include a button or a trigger structure.

“Atmosphere” refers to environmental conditions (atmospheric pressure, temperature, etc.) surrounding the spray gun system.

“Atmospheric pressure” refers to pressure exerted by the atmosphere on the spray gun system.

“Body” refers to a material form of an object.

“Needle” refers to a needle having a needle tip configured to form a needle-nozzle seal with a nozzle sealing surface. The needle and nozzle sealing surface form part of a needle valve. An adjustment knob or other portion of the spray gun platform can form an end stop for the needle.

“Fluid tight” refers to prohibiting the entrance of fluids such as water at appropriate operating pressures of a spray gun system. In at least one embodiment, the liquid can be at pressures no greater than 50 pounds per inch.

“Gas” refers to a substance or matter in a state in which it will expand freely to fill the whole of a container, having no fixed shape (unlike a solid) and no fixed volume (unlike a liquid). The gas can be used in a spraying process to atomize a bulk liquid and form a spray pattern. The gas can be used as a carrier for the liquid to assist in delivery of the fluid. Examples of gases include nitrogen, carbon dioxide, gas mixtures such as air, and even gas propellants which may be in a gaseous state at standard state conditions but liquified at higher pressures.

“Gas valve” refers to a device to control, direct, or regulate flow of the gas (and can indirectly control, direct, or regulate flow of the liquid by changing the differential pressure across a resilient flow control valve described herein) in a binary or graduated manner. Examples of a gas valve can include gate valves, poppet valves, butterfly valves, ball valves and the like.

“Grip portion” refers to a section that is configured to be gripped by a user's hand.

“Linear” refers to arranged in or extending along a straight or nearly straight line.

“Liquid” refers to coating materials that can be applied to a surface using a spray gun system including (without limitation) paints, primers, base coats, lacquers, varnishes and similar paint-like materials as well as other materials such as adhesives, sealers, fillers, putties, powder coatings, blasting powders, abrasive slurries, mold release agents and foundry dressings which may be applied in atomized or non-atomized form depending on the properties and/or the intended application of the material. In these applications, the term liquid is used generically as it may include solid particles (pigments, powders, granules, etc.) which are suspended or dissolved in a carrier liquid.

“Liquid outlet” refers to a location where a liquid exits a spray gun component or would exit the spray gun component. In at least one embodiment, the liquid outlet can be at least partially formed at a distal end of a spray gun component.

“Liquid passageway” refers to a liquid flow path within the spray gun component body.

“Liquid reservoir component” refers to a component within a liquid reservoir system. Examples of liquid reservoir components include lids, containers, cups, pouches, bags, adapters, and liquid hose assemblies.

“Liquid reservoir system” refers to a system configured to hold or transport a liquid. The liquid reservoir system can include at least a liquid reservoir component. The liquid reservoir system can include a plurality of liquid reservoir components such as a cup, and a lid. The liquid reservoir system can also include components such as liquid hose assemblies that are fluidically coupled to a drum. The liquid reservoir system can be a type of liquid source.

“Manually-operated valve” refers to a valve capable of being controlled via a mechanical linkage to an actuator. For example, the manually-operated valve can be mechanically coupled to another component such as a trigger of a spray gun platform. The manually-operated valve can translate along the spray longitudinal axis. Examples of manually-operated valves include poppet, globe valve, gate valve, ball valve, butterfly valve, plug valve, slide valve, a needle valve, a lever, or a pinch-valve. The term “manually-operated valve” excludes the resilient flow control valve. For example, even though a slit in a resilient portion can be pushed with manual pressure, the resilient flow control valve is not a “manually-operated valve” because the primary and/or intended mechanism is based on differential pressure, not manual activity.

“Mixing zone” refers to where a stream of gas exits a gas outlet and merges, interacts with, intersects, and/or atomizes a stream of liquid from a liquid outlet.

“Needle chamber” refers to the wettable needle chamber, the non-wettable needle chamber, or a discrete portion of the needle passageway.

“Needle passageway” refers to a passageway formed within a spray gun system (including the nozzle assembly and spray gun platform) configured to receive a needle and related components such as biasing mechanisms. At a first end, the needle passageway can include the nozzle sealing surface. At a second end, the needle passageway can include an opening that is sealable by an adjustable knob.

“Nozzle assembly” refers to a fluid nozzle and a device for coupling the fluid nozzle to a spray gun platform. The nozzle assembly acts to transport a gas through a gas passageway and/or transport a liquid through a liquid passageway formed therein. The gas passageway and/or the liquid passageway of the nozzle assembly is mateable with the gas passageway and/or the liquid passageway of the spray gun platform. In at least one embodiment, the nozzle assembly can include a nozzle cartridge.

“Nozzle cartridge” refers to a spray gun component having a liquid passageway for direct connection to a liquid source/liquid reservoir system and a liquid outlet. When combined with a spray gun platform, the spray gun platform itself does not include the liquid passageway but the spray gun platform can include a portion of a gas passageway for connection to the gas source. Nozzle cartridge can refer to a type of nozzle assembly.

“Releasably engaged” refers to having a fixed position relative to a part and also being removable from the part.

“Sealing structure” refers to elements or structures that seal a needle chamber (e.g., wettable, or non-wettable) or other part of the spray gun from the environment. The sealing structure can be liquid-tight such that liquid does not travel into or out from the needle chamber. Sealing structures can include plugs, stoppers, walls, welds, injection molded parts, etc.

“Sealingly engage” refers to a surface (i.e., a sealing surface) of a first body forming a fluid tight seal with a surface of a second body, either directly or indirectly (e.g., through another structure like a packing seal or frame structure).

If the first body is a resilient flow control valve having a sealing surface and the second body is a nozzle liquid passageway having an interior bore surface, then the sealing surface of the resilient flow control valve can form a fluid tight seal with the interior bore of the nozzle liquid passageway.

The term “sealingly engage” can refer to a sealing surface on a periphery of the first or second body and not the first or second body being fluid tight as a whole. For example, the resilient flow control valve may have a slit or opening which can open in response to differential pressure but is not fluid tight under certain circumstances.

“Spray equipment” refers to any equipment or component that is used to convey, store, or atomize bulk fluids into a fine spray or mist of droplets. Spray equipment can refer to devices that use air spray, airless, rotary/centrifugal, ultrasonic, or electrostatic methods.

“Spray gun” refers to a type of spray equipment. Spray gun can refer to an air spray gun that uses a low-pressure liquid stream mixed with compressed gas to atomize the liquid in a controlled manner.

“Spray gun component” refers to a component that forms part of a spray gun system. Examples of spray gun components include a spray gun platform, valve, nozzle assembly, nozzle cartridge, air cap, liquid reservoir system and liquid reservoir components thereof. The spray gun component can also include any device that physically attaches to any of the aforementioned spray gun components.

“Spray gun platform” refers to a spray gun component that has a grip portion, actuator, and connections to the gas source and optionally a liquid reservoir system. In at least one embodiment, the spray gun platform may refer to a spray gun body with an integrated liquid inlet. In at least one embodiment, the spray gun platform can manually couple to a nozzle cartridge or nozzle assembly.

“Spray gun system” refers to one or more spray gun components that, when assembled together, are configured to atomize a liquid and/or shape it into a spray. The spray gun system can use air to atomize a liquid. The spray gun can be a manual spray gun system or can be robotic, meaning attached to a robotic arm.

“Tapered region” refers to a region that is tapering from a first dimension to a second dimension. The second dimension is less than the first dimension. Dimensions can include a diameter, or perimeter and can be generally indicative of bore or opening size.

“Tubular” refers to a long, round, and hollow shape. Tubular can refer to an ellipsoidal, polygonal cross-section.

1. A spray gun comprising:
a spray gun platform having an engagement hole;
an engagement structure installed at the engagement hole;
a trigger configured to pivotably attach to the spray gun platform via the engagement structure, the trigger comprising:
a first trigger body arranged along a trigger axis, the first trigger body having a proximal end, a distal end, and a body segment at the distal end leading to a first yoke arm and a second yoke arm at the proximal end; and
a trigger-needle engagement structure positioned between the first yoke arm and second yoke arm;
wherein the first yoke arm and the second yoke arm each comprise plurality of pivot holes formed therein towards the proximal end, the plurality of pivot holes are dimensioned similarly so that each pivot hole is engageable with the engagement structure; and
a needle valve comprising a needle disposed at least partially within the spray gun platform and configured to engage with the trigger-needle engagement structure of the trigger, wherein the needle is configured to be translatable along a spray axis in response to a pivoting motion of the trigger.

2. The spray gun of claim 1, wherein the needle comprises a needle boss that is configured to engage with the trigger-needle engagement structure.

3. The spray gun of claim 2, wherein the trigger-needle engagement structure is a crossbar between the first yoke arm and the second yoke arm.

4. The spray gun of claim 11, wherein the trigger-gas valve engagement structure engages with the gas valve.

5. The spray gun of claim 1, wherein a first pivot hole of the plurality of pivot holes is aligned with the trigger axis and a second pivot hole of the plurality of pivot holes is offset from the trigger axis.

6. The spray gun of claim 5, wherein the first pivot hole and the second pivot hole are aligned along an adjustment axis and the adjustment axis is non-orthogonal to the trigger axis.

7. The spray gun of claim 1, wherein the first yoke arm and the second yoke arm each have at least three pivot holes.

8. The spray gun of claim 1, wherein the engagement structure has an axis that is perpendicular relative to the spray axis.

9. The spray gun of claim 1, wherein the trigger further comprises a second trigger body attachable to the first trigger body at a body member of the first trigger body.

10. The spray gun of claim 9, wherein the second trigger body is pivotable relative to the first trigger body.

11. The spray gun of claim 1, further comprising a nozzle assembly comprising a liquid outlet and a gas outlet adjacent to the liquid outlet, the spray gun configured to deliver liquid through the liquid outlet in response to pressurized gas flowing through the gas outlet based on actuation of a gas valve, wherein the needle valve comprises the liquid outlet.

12-13. (canceled)

14. The spray gun of claim 11, wherein the spray gun platform comprises a poppet valve that engages with both the gas valve and the needle at the trigger-needle engagement structure.

15. The spray gun of claim 14, wherein the trigger-needle engagement structure is a cutout formed within the body segment of the first trigger body.

16. The spray gun of claim 1, wherein the spray gun platform comprises a grip portion, the trigger is configured to be coplanar with the grip portion.

17. The spray gun of claim 1, wherein the plurality of pivot holes are linked through channels formed in the first trigger body between the pivot holes.

18. The spray gun of claim 1, wherein, within the plurality of pivot holes, a circumference of a pivot hole overlaps with another circumference of an adjacent pivot hole.

19. The spray gun of claim 1, wherein the engagement structure is a screw, pivot pin, or a rivet.

20. A method of adjusting the spray gun of claim 1, comprising:
removing the engagement structure from a first pivot hole to release the first trigger body from a first configuration;
aligning a second pivot hole of the first trigger body with the engagement hole which changes a position and an orientation of the trigger relative to the spray gun to a second configuration;
installing the engagement structure through the second pivot hole.

21. A method of claim 20, wherein, at rest, a first angle between the trigger axis and a grip axis of the spray gun platform in the first configuration is different from a second angle between the trigger axis and the grip axis in the second configuration.
